(19) United States
(12) Patent Application Publication
(10) Pub. No.: US 2013/0045158 A1
(43) Pub. Date: Feb. 21, 2013

(54) METHOD FOR PRODUCING MIXED OXIDES COMPRISING LITHIUM

(71) Applicants: Stipan Katusic, Bad Soden (DE); Peter Kress, Karlstein (DE)

(72) Inventors: Stipan Katusic, Bad Soden (DE); Peter Kress, Karlstein (DE)

(73) Assignee: Evonik Degussa GmbH, Essen (DE)

(21) Appl. No.: 13/639,898

(22) PCT Filed: Jun. 7, 2011
(86) PCT No.: PCT/EP2011/059340

§ 371 Date: Oct. 8, 2012

(30) Foreign Application Priority Data
Jun. 25, 2010 (EP) 10167350.7

(51) Int. Cl. C01D 15/02; C01G 51/04; C01G 23/04; C01G 53/04

(52) U.S. Cl. 423/594.4; 423/594.15; 423/594.6; 423/598

(57) ABSTRACT

Process for preparing a lithium-containing mixed oxide powder, wherein
a) a stream of a solution containing at least one lithium compound and at least one metal compound of one or more mixed oxide components in the required stoichiometric ratio is atomized by means of an atomizer gas to give an aerosol having an average droplet size of less than 100 μm,
b) the aerosol is reacted in a reaction space by means of a flame obtained from a mixture of fuel gas and air, with the total amount of oxygen being sufficient for at least complete reaction of the fuel gas and of the metal compounds,
c) the reaction stream is cooled and
d) the solid product is subsequently separated off from the reaction stream.

The invention relates to a process for preparing lithium-containing mixed oxides by means of a spray pyrolysis process.

EP-A-814524 discloses a spray pyrolysis process for preparing a lithium-manganese mixed oxide, in which lithium salts and manganese salts dissolved in a water/alcohol mixture are atomized, the aerosol formed is pyrolysed by means of external heating at from 400 to 900° C. in the presence of oxygen and the reaction product obtained is subsequently thermally treated in order to obtain a lithium-manganese mixed oxide which has an average particle diameter in the range from 1 to 5 μm and a specific surface area in the range from 2 to 10 m²/g. EP-A-824087 discloses an analogous process for preparing lithium-nickel mixed oxides or lithium cobalt mixed oxides. EP-A-876997 additionally discloses that compounds such as hydrogen peroxide or nitric acid which supply oxygen during the pyrolysis are used for preparing these mixed oxides.

A disadvantage of the processes disclosed in EP-A-814524, EP-A-824087 and EP-A-876997 is the thermophoresis to form a wall deposit which reduces the energy introduced, which is observed in many high-temperature processes.

Taniguchi et al. (Journal of Power Sources 109 (2002) 333-339) disclose a spray pyrolysis process for preparing a lithium mixed oxide having the composition LiM_{1/6}Mn_{11/16}O₄ (M=Mn, Co, Al and Ni), in which an ultrasonic atomizer is used for atomizing a solution of the nitrates in water, 0.45 mol/l. The temperature is provided by an electrically heated reactor. An ultrasonic atomizer is likewise used by Ogihara et al. (Transactions of the Materials Research Society of Japan 32 (2007) 717-720) in the spray pyrolysis to prepare Li[Ni_{1/3}Mn_{1/3}Co_{1/3}]O₂.

The preparation of the latter mixed oxide by spray pyrolysis is also described by Kang et al. (Ceramics International 33 (2007) 1093-1098). Here, solutions of the nitrates or acetates of nickel, cobalt and manganese and also lithium carbonate are used. Kang et al. (Journal of Power Sources 178 (2008) 387-392) describe the preparation of LiNi_{0.8}Co_{0.15}Mn_{0.05}O₂ by a similar process.

Pratsinis et al. (Materials Chemistry and Physics 101 (2007) 372-378) describe a spray pyrolysis process for preparing LiMn₂O₄, Li₄Ti₅O₁₂ and LiFe₅O₈. Here, lithium t-butoxide and manganese acetylacetonate or manganese 2-ethylhexanoate, lithium t-butoxide and titanium isopropoxide and lithium t-butoxide and iron naphthenate are used. Pratsinis et al. in Journal of Power Sources 189 (2009) 149-154 describe a similar process in which the acetylacetonates of lithium and manganese are dissolved in a solvent mixture of 2-ethylhexanoic acid and acetonitrile.

Disadvantages of the spray pyrolysis processes disclosed in the journal literature are their low throughputs, so that industrial implementation is not economical. In addition, these arrangements are not suitable for scaling up the processes to higher throughputs. The technical problem addressed by the present invention is therefore to provide a process which does not have the disadvantages of the spray pyrolysis processes described in the prior art.

The present invention provides a process for preparing a lithium-containing mixed oxide powder, wherein
a) a stream of a solution containing at least one lithium compound and at least one metal compound of one or more mixed oxide components in the required stoichiometric ratio is atomized by means of an atomizer gas to give an aerosol having an average droplet size of less than 100 μm,
b) the aerosol is reacted in a reaction space by means of a flame obtained from a mixture of fuel gas and air, with the total amount of oxygen being sufficient for at least complete reaction of the fuel gas and of the metal compounds,
c) the reaction stream is cooled and
d) the solid product is subsequently separated off from the reaction stream.

The process of the invention is particularly suitable for preparing mixed oxides having a BET surface area of from 0.05 to 100 m²/g, preferably from 1 to 20 m²/g. The BET surface area is determined in accordance with DIN ISO 9277.

In a particular embodiment of the invention, the solid product can be thermally treated at temperatures of from 500 to 1200° C., preferably from 800 to 1100° C., particularly preferably from 900 to 1050° C., for a period of from 2 to 36 hours after having been separated off from the reaction stream.

Suitable fuel gases can be hydrogen, methane, ethane, propane, butane and mixtures thereof. Preference is given to using hydrogen. The fuel gases can be introduced into the flame at one or more points. The amount of oxygen is, in the process of the invention, selected so that it is sufficient for at least complete reaction of the fuel gas and of the metal compounds. It is generally advantageous to use an excess of oxygen. This excess is advantageously expressed as the ratio of oxygen present/oxygen required for combustion of the fuel gas and denoted as lambda. Lambda is preferably from 1.8 to 4.0.

In a particular embodiment, the sum of the concentrations of the lithium compounds and metal compounds in the solution is at least 10% by weight, preferably from 10 to 20% by weight, particularly preferably from 12 to 18% by weight, in each case calculated as metal oxide.

In a further particular embodiment, the ratio of mass stream of the solution/volume stream of the atomizer gas, in g of solution/standard m³ of atomizer gas, is at least 500, preferably from 500 to 3000, particularly preferably from 600 to 1000.

In a further particular embodiment, the amount of metal compounds, air, fuel gas and atomizer air is selected so that 0.001 kg of mixed oxide/standard m³ of gas 0.05, preferably 0.05≦ kg of mixed oxide/standard m³ of gas≦0.02, where gas denotes the sum of the volume streams of air, fuel gas and atomizer air.

In a further preferred embodiment, a high average exit velocity of the aerosol into the reaction space, preferably of at least 50 ms⁻¹, particularly preferably from 100 to 300 ms⁻¹, and/or a low average velocity of the reaction mixture in the reaction space, preferably from 0.1 ms⁻¹ to 10 ms⁻¹, particularly preferably from 1 to 5 ms⁻¹, is/are employed.

The mixed oxide powders of the present invention are mixed oxide powders which have lithium as one component and one or more, preferably from 1 to 5, particularly preferably from 2 to 4, further metals as mixed oxide component.

The proportions of the components are not subject to any restrictions. In general, the proportions of the starting materials are selected so that the proportion of lithium in the mixed oxide is from 1 to 20% by weight, preferably from 3 to 6% by weight.

The starting materials used preferably have a purity of at least 98% by weight, particularly preferably at least 99% by weight and very particularly preferably at least 99.5% by weight.

It is essential to the present invention that the lithium compounds and metal compounds are present in a solution. To achieve solubility and to attain a suitable viscosity for atomization of the solution, the solution can be heated. In principle, it is possible to use all soluble metal compounds which are oxidizable. They can be inorganic metal compounds such as nitrates, chlorides, bromides, or organic metal compounds such as alkoxides or carboxylates. As alkoxides, preference is given to using ethoxides, n-propoxides, isopropoxides, n-butoxides and/or tert-butoxides. As carboxylates, it is possible to use the compounds based on acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid and/or lauric acid. 2-Ethyl-hexanoates or laurates can be used particularly advantageously. The solution can contain one or more inorganic metal compounds, one or more organic metal compounds or mixtures of inorganic and organic metal compounds.

The solvents can preferably be selected from the group consisting of water, C₅-C₂₀-alkanes, C₁-C₁₅-alkanecarboxylic acids and/or C₁-C₁₅-alkanols. Particular preference is given to using water or a mixture of water and an organic solvent.

As organic solvents or as constituents of organic solvent mixtures, preference is given to using alcohols such as methanol, ethanol, n-propanol, isopropanol, n-butanol or tert-butanol, diols such as ethanediol, pentanediol, 2-methyl-2,4-pentanediol, C₁-C₁₂-carboxylic acids such as acetic acid, propionic acid, butanoic acid, hexanoic acid, oxalic acid, malonic acid, succinic acid, glutaric acid, adipic acid, octanoic acid, 2-ethylhexanoic acid, valeric acid, capric acid, lauric acid. It is also possible to use benzene, toluene, naphtha and/or petroleum spirit.

As lithium compound, preference is given to using lithium nitrate and/or one or more lithium carboxylates such as lithium acetate or lithium ethylhexanoate.

As further metal compounds, preference is given to those whose metals are selected from the group consisting of Ag, Al, B, Ca, Cd, Co, Cr, Cu, Fe, Ga, Ge, In, Mg, Mn, Mo, Nb, Ni, Pd, Rh, Ru, Sc, Sn, Ti, V, Y and Zn. Particular preference is given to using metal compounds containing Co, Cr, Fe, Mn, Ni, Sn, Ti, V and Y. It can be particularly advantageous to use one or more metal compounds of Ni and Co or one or more metal compounds of Ni, Co and Mn.

The mixed oxide powders prepared by the process of the invention are particularly suitable as constituents of secondary batteries.

### EXAMPLES

### Analysis:

The d₅₀ results from the cumulative distribution curve of the volume-average size distribution. This is determined in a customary way by laser light scattering methods. For the purposes of the present invention, a Cilas 1064 instrument from Cilas is used for this purpose. A d₅₀ is the value at which 50% of the mixed oxide particles A are within the indicated size range. A d₉₀ is the value at which 90% of the mixed oxide particles A are within the indicated size range. A d₉₉ is the value at which 99% of the mixed oxide particles A are within the indicated size range.

Solutions used: for Examples 1 to 6, a solution containing the salts specified in Table 1 with water or 2-ethylhexanoic acid (2-EHA) as solvent is produced in each case.

An aerosol is produced from the solution by means of atomizer air and a nozzle and is atomized into a reaction space. Here, an H₂10₂ flame of hydrogen and air burns, and the aerosol is reacted in this. After cooling, the mixed oxide powder is separated off from gaseous materials on a filter and is thermally treated for a particular period of time in a furnace. Table 1 reports all relevant parameters for the preparation of the mixed oxide powders and also important materials properties of the powders obtained.

The process of the invention allows high throughputs and can be scaled up without problems. The products obtained display a high purity and the composition of the mixed oxides can be varied at will. If desired, mixed oxides having an adjustable particle size distribution (bimodal or trimodal) can be prepared. Such products can have good sintering properties.

TABLE 1
Starting materials and reaction parameters; materials properties of the powders

| Example | | 1 | 2 | 3 | 4 | 5 | 6 |
|---|---|---|---|---|---|---|---|
| Lithium acetate | % by | 1.08 | 1.15 | 1.21 | — | — | — |
| | weight | | | | | | |
| Lithium octoate | % by | — | — | — | 4.68 | 17.82 | 20.10 |
| | weight | | | | | | |
| Nickel(II) acetate | % by | 3.03 | — | — | — | — | — |
| | weight | | | | | | |
| Nickel(II) nitrate | % by | — | 3.20 | 4.02 | — | — | — |
| | weight | | | | | | |
| Nickel(II) octoate | % by | — | — | — | 6.94 | — | — |
| | weight | | | | | | |
| Manganese(II) | % by | 2.84 | — | — | — | — | — |
| acetate | weight | | | | | | |
| Manganese(II) | % by | — | 2.99 | 2.89 | — | — | — |
| nitrate | weight | | | | | | |
| Manganese(II) | % by | — | — | — | 6.47 | — | — |
| octoate | weight | | | | | | |
| Cobalt(II) acetate | % by | 3.04 | — | — | — | — | — |
| | weight | | | | | | |
| Cobalt(II) nitrate | % by | — | 3.21 | 2.17 | — | — | — |
| | weight | | | | | | |
| Cobalt(II) octoate | % by | — | — | — | 7.75 | 40.98 | — |
| | weight | | | | | | |
| Titanium n-butoxide | % by | — | — | — | — | — | 53.48 |
| | weight | | | | | | |
| Solvent | | H₂O | H₂O | H₂O | 2-EHA | 2-EHA | 2-EHA |
| Σ MeX¹⁾ | % by | 14.47 | 15.18 | 14.91 | 10.71 | 11.63 | 14.90 |
| | weight | | | | | | |
| m′ₛₒₗᵥ²⁾ | g/h | 2500 | 2000 | 1800 | 2000 | 1200 | 1200 |
| m′_{at. air}³⁾ | standard | 1.0 | 2.5 | 2.5 | 2.0 | 4.0¹³⁾ | 3.5¹³⁾ |
| | m³/h | | | | | | |
| m′ₛₒₗᵥ/m′_{at. air} | g/standard | 2500 | 800 | 720 | 1000 | 300 | 343 |
| | m³ | | | | | | |
| v₁⁴⁾ | m/s | 88.4 | 221.0 | 221.0 | 176.8 | 353.6 | 309.4 |
| d₉₀⁵⁾ | μm | 87 | 92 | 93 | 96 | 68 | 71 |
| Hydrogen | standard | 4.6 | 5.5 | 5.5 | 8 | 5 | 5.5 |
| | m³/h | | | | | | |
| Air | standard | 26 | 25 | 25 | 28 | 30 | 21 |
| | m³/h | | | | | | |
| Throughput⁶⁾ | kg/standard | 0.0114 | 0.0092 | 0.0081 | 0.0056 | 0.0040 | 0.0067 |
| | m³ | | | | | | |
| Lambda | | 2.37 | 1.87 | 1.87 | 1.47 | 2.52 | 1.41 |
| v₂⁷⁾ | m/s | 2.44 | 2.44 | 2.42 | 2.46 | 2.44 | 2.44 |
| t₂⁸⁾ | s | 1.23 | 1.23 | 1.24 | 1.22 | 1.23 | 1.23 |
| T_{Fl1}⁹⁾/T_{Fl2}¹⁰⁾ | ° C. | 826/571 | 874/602 | 896/632 | 1005/751 | 863/906 | 881/953 |
| T_{furnace} | ° C. | 1050 | 925 | 950 | 1020 | — | — |
| t_{heat treatment} | h | 20 | 4 | 4 | 12 | — | — |
| Proportions | % by | | | | | | |
| Li | weight | 3.75 | 3.92 | 4.25 | 5.84 | 10.54 | 11.01 |
| Ni | | 33.09 | 33.16 | 42.97 | 31.35 | — | — |
| Mn | | 29.71 | 29.62 | 29.62 | 27.68 | — | — |
| Co | | 33.44 | 33.30 | 23.16 | 35.13 | 89.46 | — |
| Ti | | — | — | — | — | — | 88.99 |
| BET surface area¹¹⁾ | m²/g | 8.0/0.1 | 5.3/0.1 | 8.0/0.1 | 16/0.7 | 15/— | 13/— |
| Particle size | μm/% | trimodal | bimodal | trimodal | n.d. | n.d. | n.d. |
| distribution¹²⁾ | | | | | | | |
| Max₁/proportion | | 0.7/22.7 | 1.9/48.8 | 0.8/23.0 | | | |
| Max₂/proportion | | 1.8/30.0 | 8.0/51.2 | 1.9/30.8 | | | |
| Max₃/proportion | | 7.0/47.3 | —/— | 7.5/46.2 | | | |

¹⁾as oxides;
²⁾mass stream of solution;
³⁾volume stream of atomizer air;
⁴⁾v₁ = average exit velocity of the aerosol into the reaction space;
⁵⁾d₉₀ of the droplets in production of the aerosol 3;
⁶⁾kg of mixed oxide/standard m³ of gas;
⁷⁾v₂ = average velocity in the reactor;
⁸⁾t₂ = average residence time in the reactor;
⁹⁾T_{Fl1} = flame temperature 50 cm from the burner mouth;
¹⁰⁾T_{Fl2} = 200 cm from the burner mouth;
¹¹⁾in each case before/after heat treatment;
¹²⁾before heat treatment;
¹³⁾N₂ instead of air.

1. A process for preparing a lithium-containing mixed oxide powder, the process comprising:
a) atomizing a stream comprising a solution comprising a lithium compound and a metal compound of a mixed oxide component in a required stoichiometric ratio with an atomizer gas, to give an aerosol having an average droplet size of less than 100 μm; and
b) reacting the aerosol in a reaction space with a flame obtained from a mixture comprising fuel gas and air, wherein a total amount of oxygen is sufficient for complete reaction of the fuel gas and of the metal compound, to obtain a reaction stream;
c) cooling the reaction stream; and then
d) separating a solid product off from the reaction stream.

2. The process of claim 1, further comprising, after separating the solid product from the reaction stream:
thermally treating the solid product at a temperature of from 500 to 1200° C. for a period of from 2 to 36 hours.

3. The process of claim 1, wherein the fuel gas is introduced into the flame at a plurality of points.

4. The process of claim 1, wherein a ratio of oxygen present from the air employed to oxygen required for combustion of the fuel gas defined as lambda, is from 1.8 to 4.0.

5. The process of claim 1, wherein the sum of the concentrations of the lithium compound and the metal compound in the solution is at least 10% by weight.

6. The process of claim 1, wherein a ratio of mass stream of the solution to volume stream of the atomizer gas, in g of solution/standard m³ of atomizer gas, is at least 500.

7. The process of claim 1, wherein the amount of the metal compound, air, fuel gas and atomizer air is selected such that 0.001≦ kg of mixed oxide/standard m³ of gas≦0.05, wherein gas denotes a sum of the volume streams of air, fuel gas, and atomizer air.

8. The process of claim 1, wherein the average exit velocity of the aerosol into the reaction space is at least 50 ms⁻¹ and the average velocity of the reaction mixture in the reaction space is from 0.1 ms⁻¹ to 10 ms⁻¹.

9. The process of claim 1, wherein the metal compound is an inorganic metal compound, an organic metal compound, or a mixture thereof.

10. The process of claim 1, wherein the solution comprises a solvent selected from the group consisting of water, a C₅-C₂₀-alkane, a C₁-C₁₅-alkanecarboxylic acid, and a C₁-C₁₅-alkanol.

11. The process of claim 1, wherein the lithium compound is lithium nitrate or a lithium carboxylate.

12. The process of claim 1, wherein the metal compound is at least one compound of a metal selected from the group of consisting of Ag, Al, B, Ca, Cd, Co, Cr, Cu, Fe, Ga, Ge, In, Mg, Mn, Mo, Nb, Ni, Pd, Rh, Ru, Sc, Sn, Ti, V, Y, and Zn.

13. The process of claim 1, wherein the metal compound is Ni compound, a Co compound, or a mixture thereof.

14. The process of claim 1, wherein the metal compound is a Ni compound, a Co compound, a Mn compound, or any mixture thereof.

15. A secondary battery, comprising the mixed oxide obtained by the process of claim 1.
